(19) United States
(12) Patent Application Publication
(10) Pub. No.: US 2026/0194681 A1
(43) Pub. Date: Jul. 9, 2026

(54) METHOD AND DEVICE FOR PROCESSING OBSERVATION DATA OF DETECTION INSTRUMENT

(71) Applicant: INSTITUTE OF GEOLOGY AND GEOPHYSICS, CHINESE ACADEMY OF SCIENCES, BEIJING CITY (CN)

(72) Inventors: PENGFEI LIANG, BEIJING CITY (CN); QINGYUN DI, BEIJING CITY (CN); WENXIU ZHANG, BEIJING CITY (CN); WENXUAN CHEN, BEIJING CITY (CN)

(21) Appl. No.: 19/011,640

(22) Filed: Jan. 7, 2025

(51) Int. Cl. G01V 3/30; E21B 49/00

(52) U.S. Cl. CPC G01V 3/30; E21B 49/00

(57) ABSTRACT

A method and a device for processing observation data of a detection instrument, include: acquiring a time-domain signal observed by each of two receiving antennas in the detection instrument; transforming the time-domain signal to acquire a transformed time-domain signal; determining a time-domain energy signal based on the time-domain signal and the transformed time-domain signal; transforming the time-domain energy signal to acquire an energy spectrum; determining detection capability information of the detection instrument based on a ratio between the energy spectrums of the two receiving antennas.

### FIELD OF THE DISCLOSURE

The present disclosure relates to the technical field of geological exploration technologies, and more particularly to a method and a device for processing observation data of a detection instrument.

### BACKGROUND OF THE DISCLOSURE

The Logging-While-Drilling (LWD) transient electromagnetic instrument is a device used for geological exploration, and detects the properties and structures of subsurface rocks through electromagnetic waves. A notable feature of this detection instrument is its ability to probe underground conditions within a range of 30 meters ahead of the drill bit, despite its relatively short instrument length. This capability to acquire geological information even at a considerable distance ahead of the drill bit is of great significance for guiding drilling operations and improving exploration efficiency.

However, this detection instrument generates a substantial amount of data, and the data processing workflow is considerably complex. For instance, it involves inversion and other intricate data processing steps, which require high computational power to analyze the exploration results. Additionally, due to limitations in data transmission rates, the data generated by the LWD transient electromagnetic instrument during downhole exploration cannot be transmitted to the surface for real-time processing. In addition, the limited computational resources available downhole cannot support such complex data processing directly.

### SUMMARY OF THE DISCLOSURE

The present disclosure provides a method and a device for processing observation data of a detection instrument, aiming to solve at least one of the problems mentioned in the above technical issues.

The present disclosure provides a method for processing observation data of a detection instrument, including:
acquiring a time-domain signal observed by each of two receiving antennas in the detection instrument;
transforming the time-domain signal to acquire a transformed time-domain signal;
determining a time-domain energy signal based on the time-domain signal and the transformed time-domain signal;
transforming the time-domain energy signal to acquire an energy spectrum; and
determining detection capability information of the detection instrument based on a ratio between the energy spectrums of the two receiving antennas.

The present disclosure provides further provides a device for processing observation data of a detection instrument, including:
an acquisition module, configured to acquire a time-domain signal observed by each of two receiving antennas of a detection instrument;
a first transformation module, configured to transform the time-domain signal to acquire a transformed time-domain signal;
a first determination module, configured to determine a time-domain energy signal based on the time-domain signal and the transformed signals;
a second transformation module, configured to transform the time-domain energy signal to acquire an energy spectrum; and
a second determination module, configured to determine detection capability information of the detection instrument based on a ratio between the energy spectrums of the two receiving antennas.

The present disclosure further provides an electronic device, including a memory, a processor, and a computer program stored in the memory and executable on the processor. When the processor executes the program, it implements the method for processing observation data of a detection instrument as described in any of the preceding claims.

The present disclosure further provides a non-transitory computer-readable storage medium storing a computer program, which, when executed by a processor, implements the method for processing observation data of a detection instrument as described in any of the preceding claims.

The method and the device for processing observation data of a detection instrument provided by the present disclosure include the following steps: acquiring the time-domain signal observed by each of the two receiving antennas of the detection instrument; transforming the time-domain signal to acquire the transformed time-domain signal; determining the time-domain energy signal based on the time-domain signal and the transformed time-domain signal; and transforming the time-domain energy signal to acquire the energy spectrum. Based on the ratio between the energy spectrums of the two receiving antennas, the detection capability information of the detection instrument is determined. By transforming the time-domain signals detected underground and processing them to acquire the final transformed energy spectrums, the present disclosure reduces the computational requirements for data processing. Furthermore, by determining the detection capability information of the detection instrument based on the ratio between the energy spectrums of the two receiving antennas, the present disclosure achieves real-time processing of observation data from the detection instrument underground.

### BRIEF DESCRIPTION OF THE DRAWINGS

To provide a clearer explanation of the technical solutions of the present disclosure or the prior art, the figures, used in the description of the embodiments or prior art are briefly introduced below. It is evident that the following figures depict some embodiments of the present disclosure. For those skilled in the art, other figures may be obtained based on these figures without creative efforts.

FIG. 1 is schematic flowchart of a method for processing observation data of a detection instrument provided by the present disclosure;

FIG. 2 is a schematic structural diagram of the detection instrument according to an embodiment of the present disclosure;

FIG. 3 is another schematic structural diagram of the detection instrument according to an embodiment of the present disclosure;

FIG. 4 is an effect diagram of a ratio between energy spectrums of an X-axis component at different boundary distances according to an embodiment of the present disclosure;

FIG. 5 is another effect diagram of the ratio between energy spectrums of the X-axis component at different boundary distances according to an embodiment of the present disclosure;

FIG. 6 is an effect diagram of a ratio between energy spectrums of a Z-axis component at different boundary distances according to an embodiment of the present disclosure;

FIG. 7 is a schematic structural diagram of a device for processing observation data of a detection instrument provided by the present disclosure; and

FIG. 8 is a schematic structural diagram of an electronic device provided by the present disclosure.

### DETAILED DESCRIPTION OF THE EXEMPLARY EMBODIMENTS

To make the objectives, technical solutions, and advantages of the present disclosure more apparent, the technical solutions of the present disclosure will be described clearly and completely below in conjunction with the accompanying drawings. It is evident that the described embodiments are part of, rather than all, the embodiments of the present disclosure. Based on the embodiments of the present disclosure, all other embodiments obtained by those skilled in the art without creative efforts shall fall within the scope of protection of the present disclosure.

The terminology used in one or more embodiments of the present disclosure is solely for the purpose of describing specific embodiments and is not intended to limit one or more embodiments of the present disclosure. In one or more embodiments of the present disclosure, the singular forms “a,” “the,” and “said” are also intended to include plural forms unless the context clearly indicates otherwise. It should also be understood that the term “and/or” as used in one or more embodiments of the present disclosure refers to any or all possible combinations of one or more associated listed items.

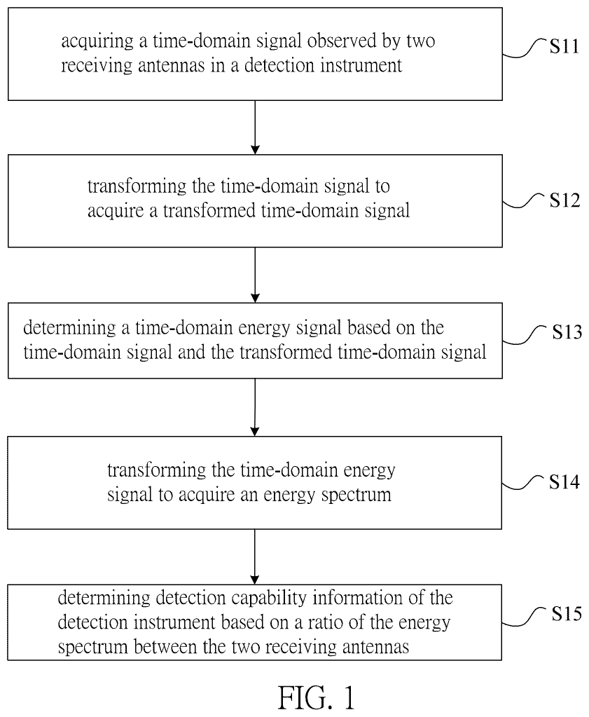

FIG. 1 is a schematic flowchart of a method for processing observation data of a detection instrument provided by the present disclosure. As shown in FIG. 1, the method for processing observation data of a detection instrument includes:

Step S11: acquiring a time-domain signal observed by each of two receiving antennas in the detection instrument.

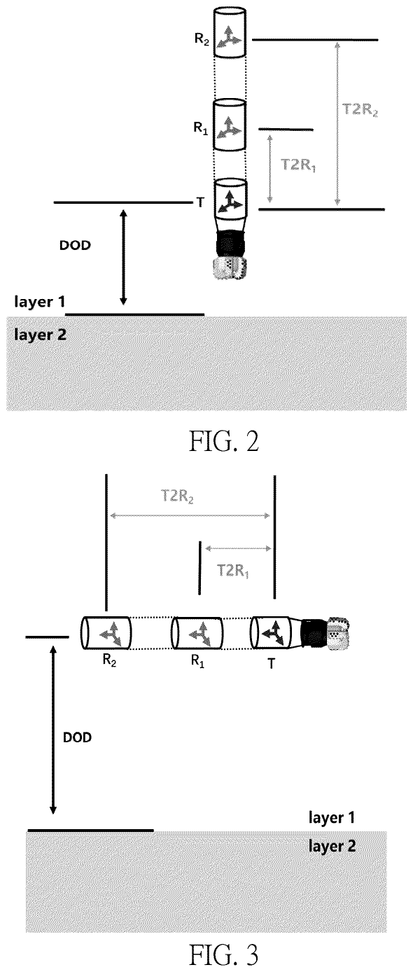

It should be noted, referring to FIGS. 2 and 3, FIG. 2 is one schematic structural diagram of the detection instrument provided in an embodiment of the present disclosure, and FIG. 3 is another schematic structural diagram of the detection instrument provided in an embodiment of the present disclosure, and the detection instrument includes one transmitting antenna and two receiving antennas. As shown in FIG. 1, T represents a three-component transmitting antenna, and R1 and R2 represent three-component receiving antennas, respectively. The transmitting antenna is used to transmit electromagnetic wave signals, and the receiving antennas are used to receive the electromagnetic wave signals reflected by a target to be tested.

It should be noted that the time-domain signal can be a time-domain signal observed by an X-axis horizontal component or a time-domain signal observed by a Z-axis component. Optionally, to determine the detection capability of the detection instrument, time-domain signals observed by the receiving antennas at different boundary distances can be collected. As shown in FIG. 2, the boundary distance refers to a distance between the transmitting antenna of the detection instrument and the stratum boundary. As shown in FIG. 3, the boundary distance refers to a distance between the detection instrument and the stratum boundary.

Step S12: transforming the time-domain signal to acquire a transformed time-domain signal.

Specifically, a Hilbert transform is performed on the time-domain signal to acquire the transformed time-domain signal. The Hilbert transform is a time-to-time transformation that converts real signals in the time domain into complex signals containing imaginary parts, thereby ensuring that the frequency spectrum of the signals only contains positive frequency components.

Step S13: determining a time-domain energy signal based on the time-domain signal and the transformed time-domain signal.

Specifically, the time-domain energy signal is acquired through a calculation based on the time-domain signal and the transformed time-domain signal. The time-domain energy signal represents energy distribution of signals in the time domain. The calculation formula for the time-domain energy signal is as follows:

$$E ( t ) = \sqrt{{S}^{2} ( t ) + {H}^{2} ( S ( t ) )}$$

S(t) represents the time-domain signal, H(S(t)) represents the transformed time-domain signal, and E(t) represents the time-domain energy signal.

Step S14: transforming the time-domain energy signal to acquire an energy spectrum.

Specifically, a Fourier transform is performed on the time-domain energy signal to acquire the energy spectrum. The Fourier transform converts the time-domain signal into a frequency-domain signal, thereby revealing the frequency component and amplitude information of the signal. The energy spectrum represents the distribution of energy signals in the frequency domain, indicating the energy content of the signals at different frequencies.

Step S15: determining detection capability information of the detection instrument based on a ratio between the energy spectrums of the two receiving antennas.

Specifically, the ratio between the energy spectrums of the two receiving antennas at any boundary distance is calculated. Based on the ratio corresponding to any boundary distance, the boundary distance corresponding to the ratio is assigned within the predetermined signal ratio range as the detection capability information of the detection instrument. For instance, the boundary distance corresponding to the ratio closest to the predetermined signal ratio range is identified as the detection capability information of the detection instrument.

In an embodiment of the present disclosure, the proposed solution includes: acquiring the time-domain signal observed by each of the two receiving antennas in the detection instrument; transforming the time-domain signal to acquire the transformed time-domain signal; determining the time-domain energy signal based on the time-domain signal and the transformed time-domain signal; transforming the time-domain energy signal to acquire the energy spectrum; and determining the detection capability information of the detection instrument based on the ratio between the energy spectrums of the two receiving antennas. By transforming the time-domain signals detected underground and processing them to acquire the final transformed energy spectrums, the present disclosure reduces the computational requirements for data processing. Furthermore, by determining the detection capability information of the detection instrument based on the ratio between the energy spectrums of the two receiving antennas, the present disclosure achieves real-time processing of observation data from the detection instrument underground.

In another embodiment of the present disclosure, determining detection capability information of the detection instrument based on a ratio between the energy spectrums of the two receiving antennas includes:
calculating a ratio corresponding to any boundary distance based on the energy spectrums of the two receiving antennas at any boundary distance; and
if the ratio meets a predetermined signal ratio range, using the boundary distance corresponding to the ratio as the detection capability information of the detection instrument.

Specifically, the ratio is calculated based on the energy spectrums of the two receiving antennas at any boundary distance. The formula for the ratio is as follows:

$$Att = 20 * log 10 ( V 2 / V 1 )$$

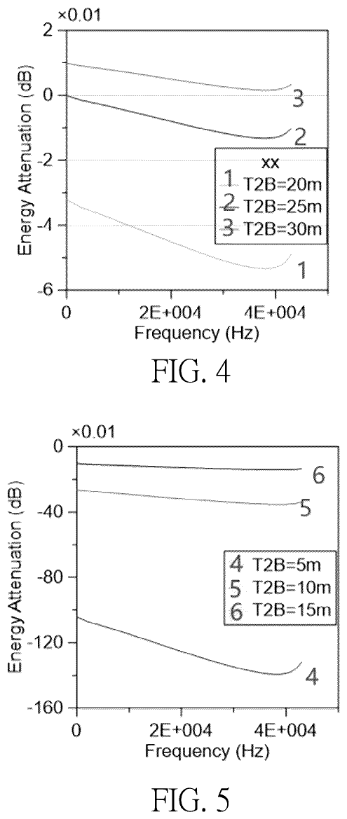

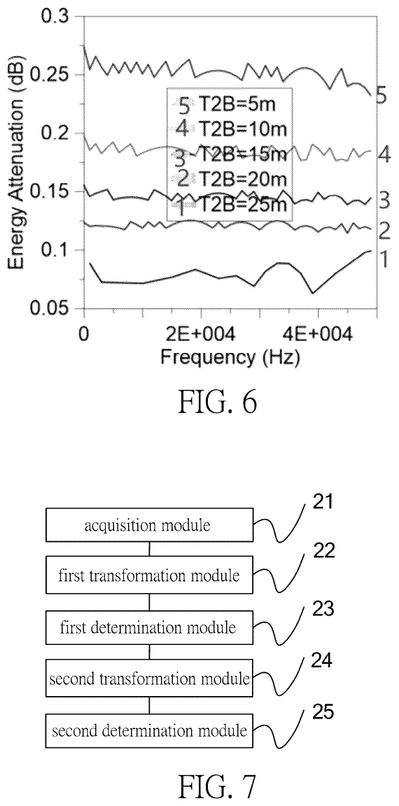

V1 and V2 respectively represent the energy spectrums corresponding to the two receiving antennas, and Att represents the ratio. Furthermore, the boundary distance corresponding to the ratio that falls within the predetermined signal ratio range is taken as the detection capability information of the detection instrument. For example, the boundary distance corresponding to a ratio close to the 0.05 dB range is considered as the detection capability information of the detection instrument. Referring to FIGS. 4 and 5, FIG. 4 is an effect diagram of the ratio between energy spectrums of an X-axis component at different boundary distances provided in an embodiment of the present disclosure and FIG. 5 is another effect diagram of the ratio between energy spectrum of the X-axis component at different boundary distances provided in an embodiment of the present disclosure. For the energy spectrum ratio of the X-axis magnetic field component: 0.05 dB is taken as the minimum threshold for signal recognition by the detection instrument and the forward detection capability of the detection instrument is determined to be 20 meters. Referring to FIG. 6, which illustrates the effect of the energy spectrum ratio for a Z-axis component at different boundary distances. For the energy spectrum ratio of the Z-axis magnetic field component: 0.05 dB is taken as the minimum threshold for signal recognition by the detection instrument and the forward detection capability of the detection instrument is determined to be 25 meters.

In one embodiment of the present disclosure, after acquiring the time-domain signal observed by each of the two receiving antennas of the detection instrument, the method further includes:
performing Fourier transform on the time-domain signal to acquire a signal spectrum; and
detecting and acquiring a stratum resistivity of the detection instrument based on the signal spectrum.

Specifically, the time-domain signal is directly subjected to Fourier transform to acquire the signal spectrum. In a specific implementation, when performing the Fourier transform on the time-domain signal, the longer the time-domain signal is, the higher the quality of the spectral signal is obtained after the Fourier transform. However, the longer the time-domain signal is, the longer the actual observation time is, which is not economical for production purposes. Therefore, a relative balance can be achieved between high signal quality and observation efficiency (shorter observation time). Furthermore, based on the signal spectrum, inversion is performed to derive the formation resistivity of the detection instrument. In one embodiment, due to the variation in measured electromagnetic signals, the resulting energy spectra also differ. Consequently, after the computation of the energy spectrum is complete, one or several spectra with the highest values can be selected as inversion data. This approach effectively enhances the accuracy of extracting large-scale underground conductivity information.

The description of a device for processing observation data of a detection instrument provided by the present disclosure is as follows. The device described below corresponds to the detection instrument observation data processing method described above and can be referenced mutually.

FIG. 7 is a schematic structural diagram of the device for processing observation data of a detection instrument provided by the present disclosure. As shown in FIG. 7, an embodiment of the device for processing observation data of a detection instrument includes:
an acquisition module 21, configured to acquire a time-domain signal observed by each of two receiving antennas of the detection instrument;
a first transformation module 22, configured to transform the time-domain signal to acquire a transformed time-domain signal;
a first determination module 23, configured to determine a time-domain energy signal based on the time-domain signal and the transformed signals;
a second transformation module 24, configured to transform the time-domain energy signal to acquire an energy spectrum; and
a second determination module 25, configured to determine detection capability information of the detection instrument based on a ratio between the energy spectrums of the two receiving antennas.

The device for processing observation data of a detection instrument further includes:
the calculation formula for the time-domain energy signal is as follows:

$$E ( t ) = \sqrt{{S}^{2} ( t ) + {H}^{2} ( S ( t ) )}$$

S(t) represents the time-domain signal, H(S(t)) represents the transformed time-domain signal, and E(t) represents the time-domain energy signal.

The device for processing observation data of a detection instrument further includes:
the time-domain signal including time-domain signals at different boundary distances, wherein the boundary distance refers to the distance between the transmitting antenna of the detection instrument and the stratum boundary or the distance between the detection instrument and the stratum boundary.

The second transformation module 25 is further configured to:
calculate a ratio corresponding to any boundary distance based on the energy spectrums of the two receiving antennas at any boundary distance; and
if the ratio meets a predetermined signal ratio range, using the boundary distance corresponding to the ratio as the detection capability information of the detection instrument.

The device for processing observation data of a detection instrument further includes:
the calculation formula for the ratio is as follows:

$$Att = 20 * log 10 ( V 2 / V 1 )$$

V1 and V2 are energy spectrums respectively corresponding to the two receiving antennas, and Att represents the ratio.

The device for processing observation data of a detection instrument further includes:
a Fourier transformation module, configured to perform Fourier transform on the time-domain signal to acquire the signal spectrum;
a detection module, configured to detect and acquire the stratum resistivity of the detection instrument based on the signal spectrum.

The first transformation module 22 is also configured to perform Hilbert transform on the time-domain signal to acquire the transformed time-domain signal.

The second transformation module 24 is also configured to perform Fourier transform on the time-domain energy signal to acquire the energy spectrum.

The device for processing observation data of a detection instrument further includes that:
the time-domain signal is a time-domain signal observed along an X-axis horizontal component or a Z-axis component.

It should be noted that the device described in the embodiment of the present disclosure can realize all the steps of the method embodiment described above and achieve the same technical effects. The identical parts and beneficial effects of this embodiment compared to the method embodiment are not specifically described here.

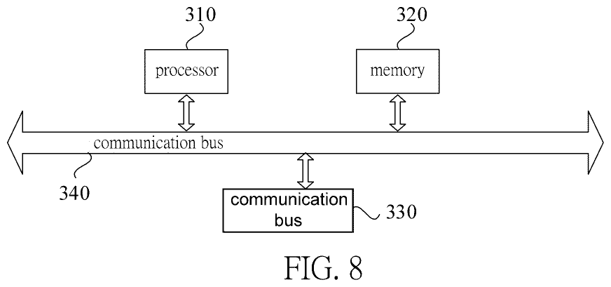

FIG. 8 illustrates a schematic structural diagram of an electronic device provided in the present disclosure. As shown in FIG. 8, the electronic device may include: a processor 310, a memory 320, a communications interface 330, and a communication bus 340. The processor 310, the memory 320, and the communications interface 330 communicate with one another through the communication bus 340. The processor 310 can invoke the logical instructions stored in the memory 320 to execute the method for processing observational data of the detection instrument.

Additionally, the logical instructions stored in the memory 320 can be implemented in the form of software functional units and, when sold or used as independent products, can be stored in a computer-readable storage medium. Based on this understanding, the essence of the technical solution of the present disclosure, or the part that contributes to the prior art, can be embodied as a software product. The computer software product is stored in a storage medium and includes several instructions to enable a computer device (such as a personal computer, server, or network device) to execute all or part of the steps of the methods described in various embodiments of the present disclosure. The aforementioned storage media may include USB drives, portable hard drives, read-only memory (ROM), random-access memory (RAM), magnetic disks, optical disks, or other media capable of storing program code.

Furthermore, the present disclosure also provides a non-transitory computer-readable storage medium on which a computer program is stored. When executed by a processor, the computer program implements the method for processing observational data of the detection instrument as described in the preceding methods.

The aforementioned embodiments of the device are illustrative only. The units described as separate components may or may not be physically separate; the components shown as units may or may not be physical entities. They may reside in a single location or be distributed across multiple network nodes. Depending on practical needs, parts or all of the modules can be selected to implement the objectives of the embodiments described herein. Those skilled in the art can understand and implement this without requiring inventive efforts.

Finally, it should be noted that the embodiments described above are merely intended to illustrate the technical solutions of the present disclosure and not to limit them. Despite the detailed description of the present disclosure with reference to the foregoing embodiments, those skilled in the art should understand that modifications or equivalent replacements to the technical solutions described in these embodiments may still be made without departing from the essence of the technical solutions provided by the present disclosure.

What is claimed is:

1. A method for processing observation data of a detection instrument, comprising:
acquiring a time-domain signal observed by each of two receiving antennas in the detection instrument;
transforming the time-domain signal to acquire a transformed time-domain signal;
determining a time-domain energy signal based on the time-domain signal and the transformed time-domain signal;
transforming the time-domain energy signal to acquire an energy spectrum; and
determining detection capability information of the detection instrument based on a ratio between the energy spectrums of the two receiving antennas.

2. The method for processing observation data of a detection instrument according to claim 1, wherein a calculation formula for the time-domain energy signal is as follows:
$$E ( t ) = \sqrt{{S}^{2} ( t ) + {H}^{2} ( S ( t ) )}$$
wherein S(t) represents the time-domain signal, H(S(t)) represents the transformed time-domain signal, and E(t) represents the time-domain energy signal.

3. The method for processing observation data of a detection instrument according to claim 1, wherein the time-domain signal includes a time-domain signal at different boundary distances, the boundary distance refers to a distance between a transmitting antenna of the detection instrument and a stratum boundary or a distance between the detection instrument and the stratum boundary; and
wherein determining detection capability information of the detection instrument based on a ratio of the energy spectrum between the two receiving antennas includes:
calculating a ratio corresponding to any boundary distance based on the energy spectrums of the two receiving antennas at any boundary distance; and
wherein, when the ratio meets a predetermined signal ratio range, using the boundary distance corresponding to the ratio as the detection capability information of the detection instrument.

4. The method for processing observation data of a detection instrument according to claim 3, wherein a calculation formula for the ratio is as follows:
$$Att = 20 * log 10 ( V 2 / V 1 )$$
wherein V1 and V2 are energy spectrums respectively corresponding to the two receiving antennas, and Att represents the ratio.

5. The method for processing observation data of a detection instrument according to claim 1, further comprising, after acquiring the time-domain signal observed by each of the two receiving antennas of the detection instrument:
performing Fourier transform on the time-domain signal to acquire a signal spectrum; and
detecting and acquiring a stratum resistivity of the detection instrument based on the signal spectrum.

6. The method for processing observation data of a detection instrument according to claim 1, wherein transforming the time-domain signal to acquire a transformed time-domain signal includes:
performing Hilbert transform on the time-domain signal to acquire the transformed time-domain signal.

7. The method for processing observation data of a detection instrument according to claim 1, wherein transforming the time-domain energy signal to acquire an energy spectrum includes:
performing Fourier transform on the time-domain energy signal to acquire the energy spectrum.

8. The method for processing observation data of a detection instrument according to claim 1, wherein the time-domain signal is a time-domain signal observed along an X-axis horizontal component or a Z-axis component.

9. A device for processing observation data of a detection instrument, comprising:
an acquisition module, configured to acquire a time-domain signal observed by each of two receiving antennas of the detection instrument;
a first transformation module, configured to transform the time-domain signal to acquire a transformed time-domain signal;
a first determination module, configured to determine a time-domain energy signal based on the time-domain signal and the transformed signals;
a second transformation module, configured to transform the time-domain energy signal to acquire an energy spectrum; and
a second determination module, configured to determine detection capability information of the detection instrument based on a ratio between the energy spectrums of the two receiving antennas.
